(19) United States
(12) Patent Application Publication
(10) Pub. No.: US 2008/0047581 A1
(43) Pub. Date: Feb. 28, 2008

(54) Vapor phase growth and apparatus and its cleaning method

(76) Inventor: Shinji Miyazaki, Kamakura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/785,184

(22) Filed: Apr. 16, 2007

(30) Foreign Application Priority Data
Apr. 17, 2006 (JP) 2006-113691

(51) Int. Cl. B08B 3/00; B08B 6/00

(52) U.S. Cl. 134/1.3; 134/56 R

(57) ABSTRACT

A mass flow controller is connected to an exhaust path of a reaction chamber. A controller detects cleaning completion in accordance with a change of an output signal of the mass flow controller in cleaning the reaction chamber.

### CROSS-REFERENCE TO RELATED APPLICATIONS

This application is based upon and claims the benefit of priority from prior Japanese Patent Application No. 2006-113691, filed Apr. 17, 2006, the entire contents of which are incorporated herein by reference.

### BACKGROUND OF THE INVENTION

1. Field of the Invention

The present invention relates to a low pressure chemical vapor deposition (LP-CVD) apparatus used for manufacturing semiconductor devices, and in particular, to its cleaning method.

2. Description of the Related Art

In a LP-CVD apparatus, a by-product is deposited on an inner wall of a tube used as a reaction chamber. If a film consisting of the deposited by-product peels off, particles are produced in the tube. This is a factor of reducing the yield of products. For this reason, when the film deposited in the tube reaches a predetermined thickness, the tube is periodically cleaned, and thereby, the tube is kept in a clean state.

Conventionally, the following method has been disclosed as the technique of cleaning a reaction chamber (e.g., see Jpn. Pat. Appln. KOKAI Publication No. 2002-151417). According to the method, a cleaning gas is introduced into a chamber in a state that high-frequency power is applied to the chamber inner wall. The controller monitors the voltage of the high-frequency power and calculates the gradient of a voltage drop-down curve. When the gradient value reaches a predetermined value, the controller disconnects the high-frequency power, and then, a mass flow controller shut off the cleaning gas. Moreover, the method of using plasma cleaning of the CVD apparatus has been disclosed (e.g., see Jpn. Pat. Appln. KOKAI Publication No. 11-74258).

For example, the following methods are given as other methods of cleaning the tube. One is wet cleaning using a cleaning liquid, and another is gas cleaning using gas. However, according to wet cleaning, the following various processes are required. Specifically, the apparatus is decomposed to cleaning it, and thereafter, again constructed. Further, conditions must be confirmed. For this reason, much time is taken to clean the tube, and thus, this is a factor of reducing a processing operation rate of the apparatus.

According to the gas cleaning method of using gas such as ClF₃, F₂ and HF, there is no need of decomposing and reconstructing the apparatus. Therefore, it is possible to prevent the operation rate of the apparatus of being reduced. Moreover, the gas cleaning method has the advantage that it is possible to etch a film, which is hard to be removed by wet cleaning. However, the etching condition of a deposited film must be confirmed via a test process. Specifically, in the test process, time etching the deposited film is determined from etching amount information obtained by etching the deposited film for a predetermined time. A visibly confirmable film is confirmed via visible determination. However, the visible confirmation in the test process must be made every time the composition condition of film and the accumulated film thickness before etching change. For this reason, there is a problem that the visible confirmation is troublesome.

Moreover, the following method has been proposed. According to the method, a cleaning gas is introduced into a chamber, and then, decomposition gas of the deposited film discharged from the chamber is monitored. However, an expensive analyzer must be provided to monitor the decomposition gas. In addition, the analyzer has late response speed; for this reason, cleaning completion detection is delayed. In particular, the following problem arises. Specifically, if a thin film is cleaned, cleaning is continued after the deposited film is removed; for this reason, the chamber receives an influence by etching. Therefore, the foregoing analyzer is not suitable as production equipments.

There has been disclosed a method of monitoring a reaction heat in etching using a thermocouple attached into the chamber to detect etching completion. There has been proposed to use the foregoing method applied to the method of cleaning the deposited film. However, excluding a polysilicon film, TEOS film and silicon nitride film have no reaction heat. Thus, the foregoing method is applicable to specific films only.

As described above, according to the conventional gas cleaning method, it is difficult to accurately detect the cleaning completion. Therefore, it is desired to provide a vapor phase growth apparatus, which can accurately detect the cleaning completion, and a method of manufacturing semiconductor devices using it.

### BRIEF SUMMARY OF THE INVENTION

According to a first aspect of the invention, there is provided a vapor phase growth apparatus comprising: a mass flow controller connected to an exhaust path of a reaction chamber; and a controller detecting cleaning completion in accordance with a change of an output signal of the mass flow controller in cleaning the reaction chamber.

According to a second aspect of the invention, there is provided a cleaning method of a semiconductor manufacturing apparatus, comprising: introducing a cleaning gas into a reaction chamber to start cleaning; and detecting a change of an output signal of a mass flow controller connected to an exhaust path of the reaction chamber to complete cleaning.

### BRIEF DESCRIPTION OF THE SEVERAL VIEWS OF THE DRAWING

FIGS. 1A to 1D are a view to explain the principle of a first embodiment;

FIG. 2 is a view schematically showing the configuration of a vapor phase growth apparatus according to a first embodiment;

FIG. 3 is a view schematically showing the configuration of a mass flow controller shown in FIG. 2;

FIG. 4 is a graph to explain the output characteristic of a capillary flow rate sensor shown in FIG. 3;

FIG. 5 is a flowchart to explain a cleaning process; and

FIG. 6 is a view schematically showing the configuration of a vapor phase growth apparatus according to a second embodiment.

### DETAILED DESCRIPTION OF THE INVENTION

Various embodiments of the present invention will be hereinafter described with reference to the accompanying drawings.

### First Embodiment

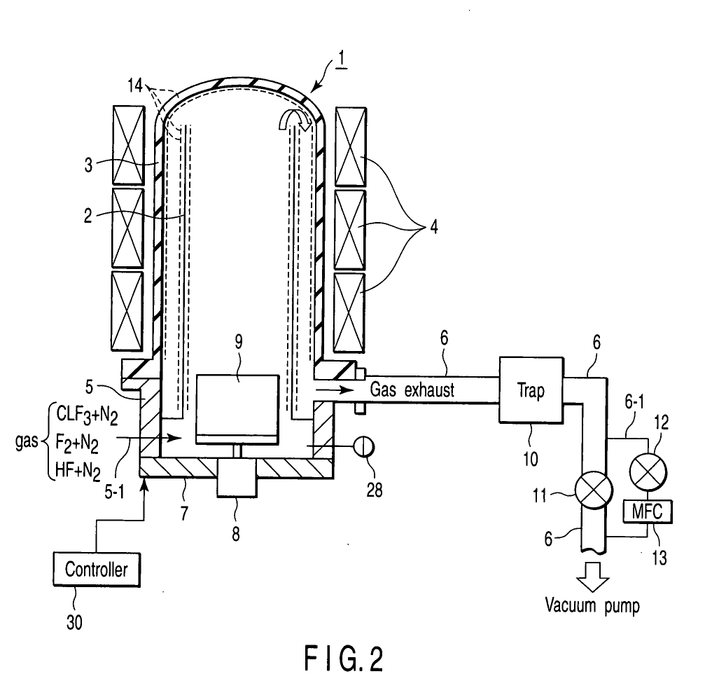

FIG. 2 is a view schematically showing the configuration of a vapor phase growth apparatus according to a first embodiment. A reaction chamber 1 is composed of inner and outer tubes 2 and 3 consisting of quartz. Heaters 4 are arranged around the outer tube 2. The reaction chamber 1 is provided with a manifold 5 at the lower portion. The manifold 5 is attached with a cap 7. The center portion of the cap 7 is provided with a rotary mechanism 8. A boat is provided on a heat-retaining cylinder 9 linking with the rotary mechanism 8. Several wafers are placed on the boat. The inside of the reaction chamber 1 is heated to a predetermined temperature by the heaters 4.

The manifold 5 is provided with several ports 5-1 and an exhaust pipe 6. These several ports 5-1 are used to introduce each of several gases into the reaction chamber 1. The exhaust pipe 6 is used as an exhaust path for exhausting gases in the reaction chamber 1. The exhaust pipe 6 is provided with trap 10, main valve 11 and vacuum exhaust pump (not shown). A branch pipe 6-1 of the exhaust pipe 6 is further provided with a sub-valve 12. The downstream side of the sub-valve 12 is provided with a mass flow controller (MFC) 13, for example. A controller controls the whole of the operation of the vapor phase growth apparatus. The operation of the controller 30 will be described later.

Polysilicon and silicon nitride are deposited on the inner and outer tubes 2 and 3 in accordance with the wafer process; as a result, a deposited film 14 is formed. When the deposited film 14 reaches a predetermined accumulated film thickness, gas cleaning is carried out with respect to the reaction chamber 1.

According to the foregoing gas cleaning, etching source such as ClF₃, HF and F₂ is mixed with N₂. And then, the mixed gas is introduced into the reaction chamber 1 heated by the heater 4 via the port 5-1 of the manifold 5. In the reaction chamber 1, the introduced gas reacts with the deposited film 14, and thus, etching is carried out from the inner tube 2 toward the outer tube 3. The introduced gas and the deposited film 14 are decomposed, and thereby, a by-product gas is produced. The by-product gas is discharged via the exhaust pipe 6 using the vacuum pump. The mass flow controller 13 provided on the branch pipe 6-1 of the exhaust pipe 6 measures a flow rate.

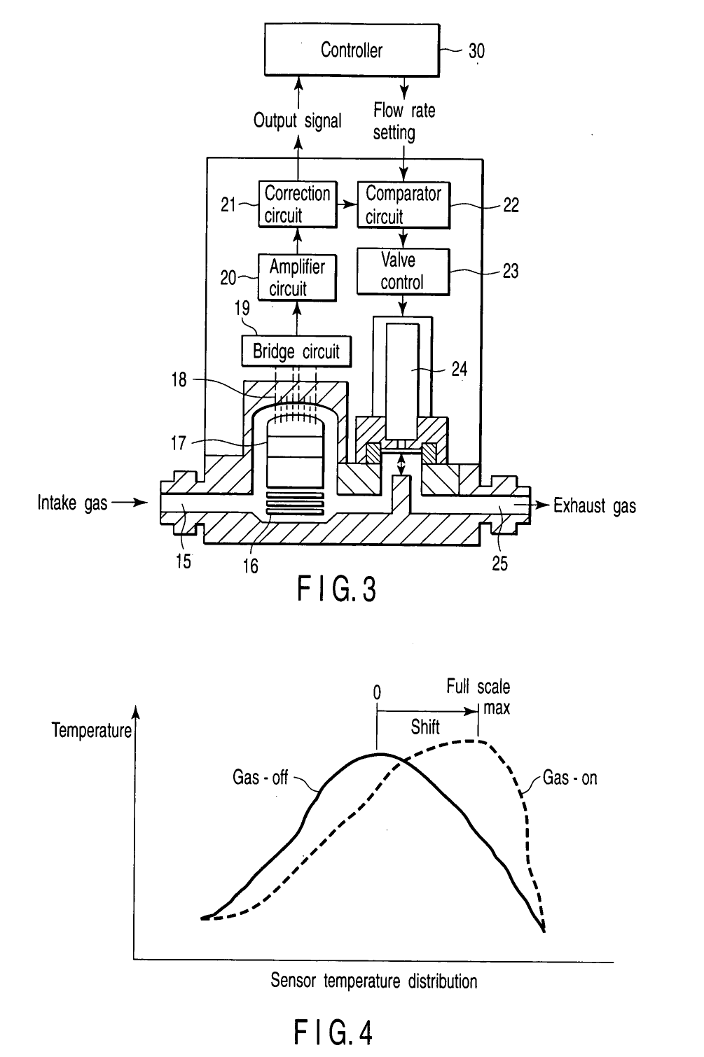

FIG. 3 is a view schematically showing the configuration of the mass flow controller 13. The mass flow controller 13 has inlet port 15 to which gas is introduced, bypass 16 with laminar flow device, capillary flow rate sensor 17 and sensor coil 18. The mass flow controller 13 further has bridge circuit 19, amplifier circuit 20, correction circuit 21, comparator circuit 22, valve control circuit 23, valve 24 and outlet port 25. The sensor coil 18 is connected to the bridge circuit 19. The bridge circuit 19 is connected to the amplifier circuit 20. The amplifier circuit 20 is connected to the correction circuit 21. An output signal of the correction circuit 20 is supplied to the controller 30 while being supplied to the comparator circuit 22. The comparator circuit 22 compares the output signal of the correction circuit 21 with a signal corresponding to a preset flow rate supplied from the controller 30. An output signal of the comparator circuit 22 is supplied to the valve control circuit 23. The valve 24 is actuated via the valve control circuit 23 to control a gas flow rate discharged from the outlet port 25.

The foregoing structure is given, and thereby, gas is introduced from the inlet 15, and distributed into two sides, that is, the bypass 16 and the flow rate sensor 17. The coil 18 generates a current in accordance with the temperature difference produced by which the distributed gas flows. The bridge circuit 19 detects the generated current as a voltage. The voltage detected by the bridge circuit 19 is supplied to the controller 30 via amplifier circuit 20 and correction circuit 21 while being supplied to the comparator circuit 22. The comparator circuit 22 compares the output signal of the correction circuit 21 with a preset flow rate (voltage value) supplied from the controller 30. The output signal of the comparator circuit 22 is supplied to the valve control circuit 23, and then, the valve 24 controls the gas flow rate discharged from the outlet port 25.

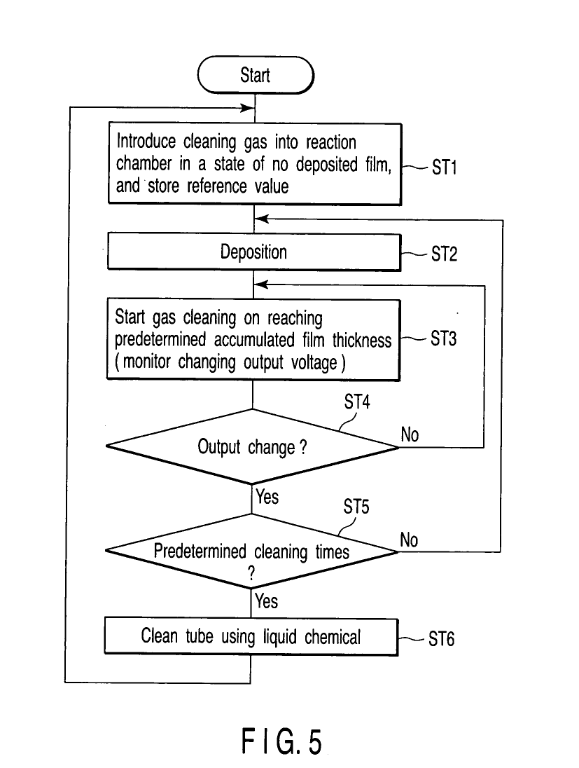

FIG. 4 shows the output characteristic of the flow rate sensor 17. A solid line shows the case where gas is flowing in the sensor 17, and a dotted line shows the case where gas is not flowing in the sensor 17. As seen from FIG. 4, the temperature change of the flow rate sensor 17, that is, distribution peak of the flow rate sensor shifts between when gas does not flow and when it is flowing. Usually, the maximum shift is given as the maximum flow rate, and thus, scale is determined. The mass flow controller 13 makes corrections so that the shift detected by the bridge circuit 19 is returned to a balanced state. The mass flow controller 13 compares the corrections with the preset flow rate supplied from the controller 30, and then, fed back the comparison result to the valve 24.

The controller 30 also controls cleaning of the reaction chamber 1. Specifically, when cleaning starts, the controller supplies cleaning gas into the reaction chamber 1. When the output signal of the mass flow controller 13 is approximately equal to a reference value, the controller 30 stops the supply of the cleaning gas, and thus, cleaning is completed.

For example, a mass flow meter is usable in place of the foregoing mass flow controller 13. The mass flow meter has the configuration of removing valve control circuit 23 and valve 24 from the mass flow controller 13. The mass flow meter is used, and thereby, gas flow rate only is detected. In the following description, the case of using the mass flow controller 13 is explained. The same description is given even if the mass flow meter is used.

In general, the mass flow controller is arranged at a gas supplier on the upstream side with respect to the reaction chamber. The temperature distribution of the mass flow controller is previously known in accordance with the kind of gas singly used. Moreover, two-mixed gas diluted by base gas such as N₂ is given. In this case, except the case where the mixing ratio is special, the temperature distribution of the mass flow controller is already known.

On the contrary, according to the first embodiment, the mass flow controller 13 is not arranged at a gas supplier on the upstream side of the port 5-1, but arranged at the branch pipe 6-1 of the exhaust pipe 6. The temperature distribution of the introduced gas given as etching source is already known. However, the deposited film 14 is decomposed in the reaction chamber 1; as a result, the produced by-product gas contains various gases. When the by-product gas passes through the mass flow controller 13, the mass flow controller 13 outputs a special signal because of having no predetermined condition of the temperature distribution relevant to the by-product gas.

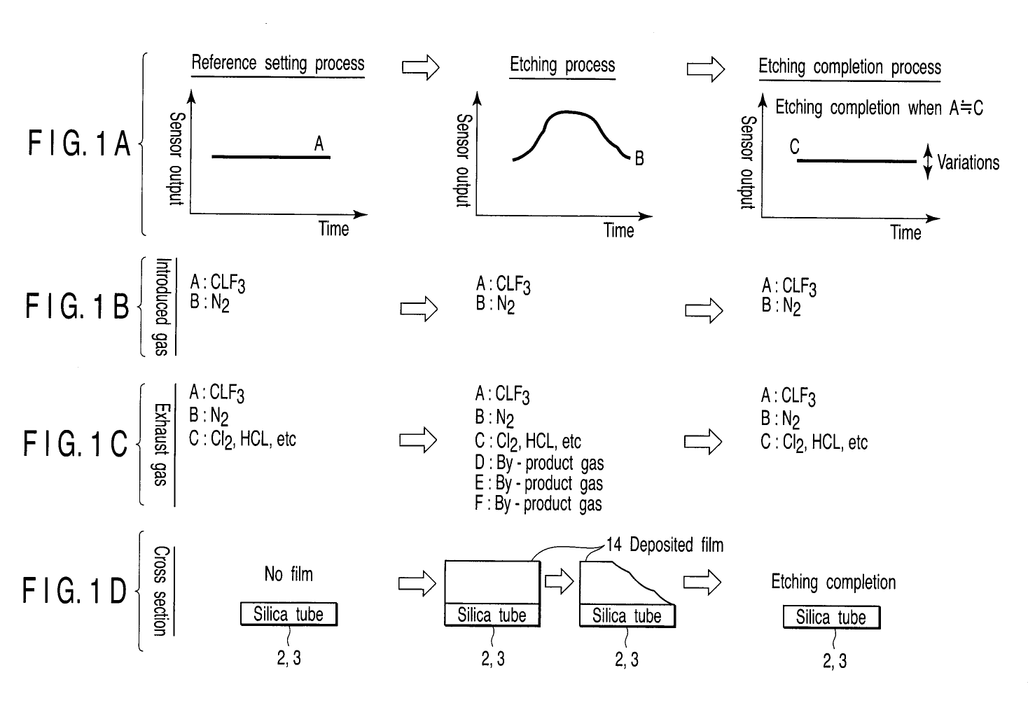

FIG. 1A to FIG. 1D shows the principle of the first embodiment. FIG. 1A shows sensor output in a reference setting process, an etching process and an etching completion process, respectively. FIG. 1B shows gases introduced to the reaction chamber in the reference setting process, the etching process and the etching completion process, respectively. FIG. 1C shows gases exhausted from the reaction chamber in the reference setting process, the etching process and the etching completion process, respectively. FIG. 1D shows a state of the reaction chamber in the reference setting process, the etching process and the etching completion process, respectively.

In a reference setting process, as shown in FIG. 1D, no deposited film 14 is given in inner and outer tubes 2 and 3 of the reaction chamber. In the state, etching source gas A and B given as cleaning gas shown in FIG. 1B are introduced into tubes 2 and 3. FIG. 1A shows a sensor output when the etching source gas A and B are introduced into tubes 2 and 3. In this case, gas shown in FIG. 1C is discharged as an exhaust gas. The sensor output (output signal of mass flow controller 13) in a state of having no deposited film 14 in tubes 2 and 3 is stored as a reference value in the controller 30. The foregoing reference setting process is carried out just after tubes 2 and 3 are assembled.

In the etching process, FIG. 1A shows an output signal of the mass flow controller 13 when etching source gases shown in FIG. 1B are introduced in a state that the deposited film 14 exists on tubes 2 and 3 shown in FIG. 1D. In this case, gases shown in FIG. 1C are discharged. When the deposited film 14 is etched in tubes 2 and 3, some by-product gases shown by D, E and F in FIG. 1C are produced. The mass flow controller 13 has no predetermined condition of the temperature distribution of the by-product gas. For this reason, the sensor output becomes a specific signal as seen from FIG. 1A.

Thereafter, when the deposited film 14 is removed in the reaction chamber 1 as shown in FIG. 1D, the exhaust gas becomes gas shown in FIG. 1C. In this case, the sensor output of the etching completion process of FIG. 1A becomes approximately equal to that shown in the reference setting process. This state is set as etching completion, that is, cleaning completion.

As described above, in the etching process, the sensor output becomes a specific signal; however, when etching is completed, the sensor output becomes a constant value. A change of the sensor output is detected, and thereby, gas cleaning completion of tubes 2 and 3 is detectable; therefore, in-situ monitor is possible.

FIG. 5 shows the flow of operation procedures of the controller 30.

The reference setting process is carried out (S1). For example, tube is assembled, and thereafter, cleaning gas is introduced into the reaction chamber in a state that tubes 2 and 3 are not formed with the deposited film 14. In this state, a reference value is set based on the output signal of the mass flow controller 13. Thereafter, a predetermined wafer process is carried out (S2). The wafer process is repeated. Then, when the deposited film 14 deposited on tubes 2 and 3 reaches a predetermined accumulated film thickness, cleaning process is started in the reaction chamber 1 (S3). Specifically, cleaning gases are introduced into the reaction chamber 1, and then, cleaning of tubes 2 and 3 is started. During the cleaning process, the controller 30 monitors the output signal of the mass flow controller 13 (S4). While the output signal of the mass flow controller 1 shows a specific change, cleaning is continued. On the other hand, when the output signal of the mass flow controller 1 becomes a state of showing a constant value, and is approximately equal to the reference value, cleaning is completed.

Thereafter, the number of cleaning times is detected (S5), if the number of cleaning times is less than a predetermined value, the control flow proceeds to step S2, a predetermined wafer process is repeated. If the number of cleaning times is more than the predetermined value, tubes 2 and 3 is decomposed to clean them using chemical liquid (S6). Then, cleaning is completed, and in a state that tubes 2 and 3 are assembled, the reference value is newly set in step S1.

According to the first embodiment, the mass flow controller 13 is connected to the exhaust pipe of the reaction chamber 1. In gas cleaning of the reaction chamber, the output signal of the mass flow controller 13 is monitored. The output signal changes from an unstable state having specific variations to a stable state, and in the stable state, the output signal of the mass flow controller 13 becomes approximately equal to preset reference value. In this case, cleaning is completed. Therefore, cleaning completion is accurately detectable using low-cost mass flow controller 13 without providing a conventional expensive analyzer.

In addition, the mass flow controller 13 has high response speed; therefore, cleaning completion is quickly detectable. This serves to reduce damages of tubes 2 and 3 due to cleaning.

The mass flow controller 13 has the advantage that there is no failure under the use condition as sensor even if high-concentration gas flows therein.

If a heater built-in type mass flow controller is used, it is applicable to cleaning of films having no exothermic reaction, that is, TEOS film and nitride film. Therefore, the foregoing mass flow controller is applicable to cleaning of various deposited films.

According to the first embodiment, gas cleaning of the reaction chamber has been described. The present invention is not limited to the foregoing case. For example, the present invention is applicable to the following cases. One is the case of monitoring gas remaining in the reaction chamber in the wafer process. Another is the case of detecting degas when the reaction chamber reach a de-vacuum state.

If the specification of the mass flow controller is changed from an analog model into a digital model, gas mixing ratio and full scale are stored in the mass flow controller 13. Thus, etching source is changed in the same apparatus, and combined to perform cleaning. In also case, cleaning completion is detectable with high accuracy.

### Second Embodiment

In the vapor phase growth apparatus, the following matter has been known. Specifically, by-products are deposited on the exhaust pipe in addition to films deposited on the inner wall surface of the tube. The vapor phase growth apparatus including gas cleaning mechanism has the following advantage. In this case, the maintenance frequency of decomposing the tube and cleaning it using chemical liquid is inevitably reduced. However, the by-product in the exhaust pipe is a factor of generating particles; therefore, it is preferably removed. The deposited film in the exhaust pipe does not have a stable film composition unlike the deposited film in the reaction chamber. For this reason, the deposited film in the exhaust pipe is not removed using cleaning gas introduced into the reaction chamber. In this case, there is a need of changing the kind of the cleaning gas to carry out etching.

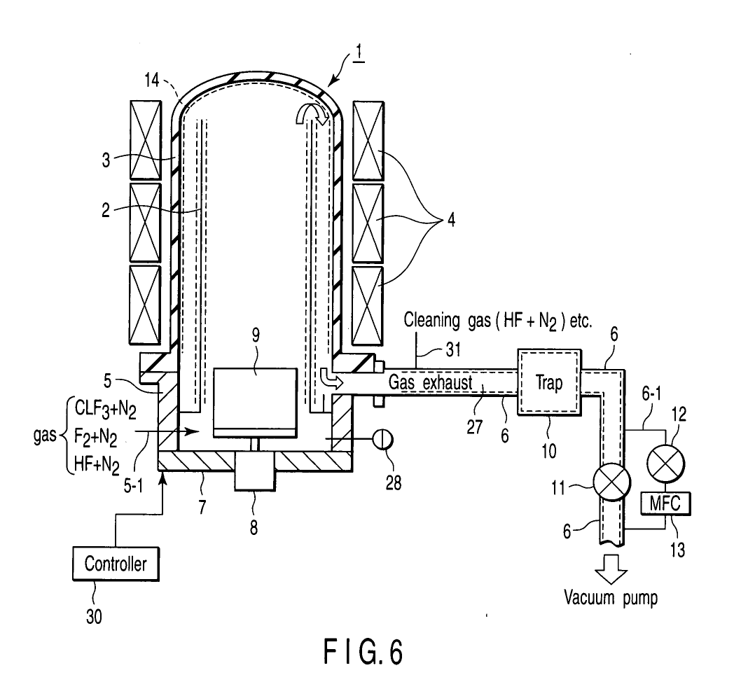

FIG. 6 is a view showing a vapor phase growth apparatus according to a second embodiment. FIG. 6 shows the case of cleaning the exhaust pipe 6. In FIG. 6, the same reference numerals are used to designate portions identical to FIG. 2. As seen from FIG. 6, the exhaust pipe 6 is provided with a port 31 for introducing exhaust-only cleaning gas in the vicinity of the manifold 5. For example, HF+N₂ gas is introduced as cleaning gas into the exhaust pipe from the port 31.

The structure is given, and thereby, the controller 30 makes the following operation. The controller 30 determines a reference value from the output signal of the mass flow controller 13 when etching is carried out in a state that no deposited film 27 exists in the exhaust pipe 6. Then, the controller 30 detects a change of the output signal of the mass flow controller 13 in cleaning like the first embodiment. By doing so, cleaning completion of the exhaust pipe 6 is detectable.

According to the second embodiment, gas cleaning of the exhaust pipe 6 is performed with high accuracy.

Moreover, the tubes 2 and 3 are cleaned while the exhaust pipe 6 is cleaned. In this case, two cleaning gases used for tubes 2, 3 and for the exhaust pipe 6 are required. Thus, the apparatus is combined with the foregoing digital model mass flow controller, and thereby, high cleaning efficiency is obtained.

According to the first and second embodiments, the mass flow controller 13 detects the existence of unknown gas having no clear composition, and thereby, tubes and exhaust pipe are cleaned. For example, completion detection function of the firs and second embodiments is usable as other function.

For example, the degree of vacuum of the vapor phase growth apparatus is managed using a pressure monitor such as baratoron gage. In this case, the degree of vacuum of the vapor phase growth apparatus can be managed using the first and second embodiments. In de-vacuum of the reaction chamber, arrival pressure delay is due to a generation of degas remarkably appearing in a TEOS film. In the first and second embodiments, the output signal of the mass flow controller 13 specially changes in a state that unknown gas exists. Thus, the change is monitored, and thereby, the mass flow controller 13 is usable as a degas monitor. Specifically, when the output signal of the mass flow controller 13 is in a state of becoming a fixed value, it is possible to make detection that the degas is removed.

Moreover, the first and second embodiments are applicable to the following cases. Specifically, in the wafer process, the mass flow controller is usable as residual gas monitor in the furnace just after stopping the introduction of film generation gas. In sequential deposition of alternately introducing different gases to form a film, gas introduction change timing is detected. In this case, the completion detecting function of the first and second embodiments is high speed; therefore, the operation efficiency of the apparatus is improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vapor phase growth apparatus comprising:
a mass flow controller connected to an exhaust path of a reaction chamber; and
a controller detecting cleaning completion in accordance with a change of an output signal of the mass flow controller in cleaning the reaction chamber.

2. The apparatus according to claim 1, wherein the controller stores the output signal of the mass flow controller when a cleaning gas is introduced into the reaction chamber as a reference value an in a state that no deposited film is formed in the reaction chamber.

3. The apparatus according to claim 2, wherein the controller completes cleaning when the output signal of the mass flow controller becomes approximately equal to the reference value in cleaning.

4. The apparatus according to claim 2, wherein the exhaust path has a cleaning gas introduction portion.

5. The apparatus according to claim 4, wherein the controller detects cleaning completion according to a change of the output signal of the mass flow controller in cleaning the exhaust path.

6. The apparatus according to claim 5, wherein the mass flow controller outputs a specific signal in cleaning, and outputs a constant signal after cleaning is completed.

7. A cleaning method of a semiconductor manufacturing apparatus, comprising:
introducing a cleaning gas into a reaction chamber to start cleaning; and
detecting a change of an output signal of a mass flow controller connected to an exhaust path of the reaction chamber to complete cleaning.

8. The method according to claim 7, further comprising:
introducing a cleaning gas into the reaction chamber in a state that no deposited film is formed in the reaction chamber before cleaning is started, and setting a reference value based on the output signal of the mass flow controller.

9. The method according to claim 8, further comprising:
processing a substrate in the reaction chamber after setting the reference value.

10. The method according to claim 7, further comprising:
detecting the number of cleaning times; and
processing the substrate placed in the reaction chamber when the number of cleaning times does not reach a predetermined value.

11. The method according to claim 10, further comprising:
cleaning the reaction chamber using a chemical liquid when the number of cleaning times reaches a predetermined value.

12. The method according to claim 8, wherein the mass flow controller outputs a specific signal in cleaning, and outputs a constant signal after cleaning is completed.

13. A cleaning method of a semiconductor manufacturing apparatus, comprising:
starting cleaning of an exhaust path of a reaction chamber; and
detecting a change of an output signal of a mass flow controller connected to the exhaust path to complete cleaning.

14. The method according to claim 13, further comprising:
introducing a cleaning gas into the reaction chamber in a state that no deposited film is formed in the reaction chamber before cleaning is started, and setting a reference value based on the output signal of the mass flow controller.

15. The method according to claim 13, further comprising:
detecting the number of cleaning times; and
processing the substrate placed in the reaction chamber when the number of cleaning times does not reach a predetermined value.

16. The method according to claim 15, further comprising:
cleaning the reaction chamber using a chemical liquid when the number of cleaning times reaches a predetermined value.

17. The method according to claim 14, wherein the mass flow controller outputs a specific signal in cleaning, and outputs a constant signal after cleaning is completed.
